(19) United States
(12) Patent Application Publication
(10) Pub. No.: US 2011/0238752 A1
(43) Pub. Date: Sep. 29, 2011

(54) VEHICLE BASED SOCIAL NETWORKING

(75) Inventors: John P. Weiss, Shelby Township, MI (US); Cody R. Hansen, Shelby Township, MI (US); Andrew W. Gellatly, Macomb, MI (US); Matthew M. Highstrom, South Lyon, MI (US); Bhavna Mathur, Novi, MI (US)

(73) Assignee: GM GLOBAL TECHNOLOGY OPERATIONS, INC., Detroit, MI (US)

(21) Appl. No.: 12/748,779

(22) Filed: Mar. 29, 2010

(51) Int. Cl. G06F 15/16; G01C 21/00; H04M 3/42

(52) U.S. Cl. 709/204; 701/207; 701/204; 455/415

(57) ABSTRACT

A social networking hub located in an automobile that provides updates to a social networking site includes an information gathering module that receives and stores information from one or more information sources. The hub also includes an update manager that receives information from the information gathering module and provides some or all of the information to the social networking site through an internet connection.

### FIELD OF THE INVENTION

The invention relates to automobiles and, more particularly, to integrating a vehicle infotainment system into a passenger's social network.

### BACKGROUND

Automobiles, including, cars and trucks, have long included entertainment systems. In particular, automobiles have long included radio tuners, compact disk players, and other means of delivering audio entertainment to passengers.

Recently, cellular phones and navigation systems have been integrated into automobile entertainment systems. An automotive navigation system is a satellite navigation system designed for use in automobiles. A navigation system typically uses a global positioning system (GPS) navigation device to acquire position data to locate the automobile on a road in the unit's map database. Using the map database, the unit can give directions to other locations along roads also in its database.

A system having both entertainment and informational (i.e., cellular phone and/or navigation system) capabilities shall be referred to herein as an “infotainment” system.

Social networking has become increasingly more prevalent. A social network service focuses on building online communities of people who share interests and/or activities, or who are interested in exploring the interests and activities of others. Most social network services are web based and provide a variety of ways for users to interact, such as e-mail and instant messaging services. Social networking sites may be accessed by, for example, cellular phones or internet connections.

### SUMMARY

In an exemplary embodiment, a social networking hub located in an automobile that provides updates to a social networking site is disclosed. The hub of this embodiment includes an information gathering module that receives and stores information from one or more information sources. The hub of this embodiment also includes an update manager that receives information from the information gathering module and provides some or all of the information to the social networking site through an internet connection.

In another embodiment, a method of providing information related to a passenger of an automobile to the passenger's social networking site is disclosed. The method includes receiving the information at a social networking hub of an infotainment system of the automobile; determining the information is to be uploaded to the social networking site; creating a connection from the infotainment system to the social networking site over the Internet; and uploading the information.

In yet another embodiment, a computer program product including a computer readable medium with program segments for, when executed on a computer device, causing the computer device to implement a method for operating an infotainment system is disclosed. The method includes receiving the information at a social networking hub of an infotainment system of the automobile; determining the information is to be uploaded to the social networking site; creating a connection from the infotainment system to the social networking site over the Internet; and uploading the information.

The above features and advantages, and other features and advantages of the present invention are readily apparent from the following detailed description of the best modes for carrying out the invention when taken in conjunction with the accompanying drawings.

### BRIEF DESCRIPTION OF THE DRAWINGS

FIG. 1 shows an example of an infotainment system that may be implemented in an automobile;

FIG. 2 shows a more detailed infotainment system according to an embodiment of the invention; and

FIG. 3 shows a flow chart of a method according to an embodiment of the invention; and

FIG. 4 shows a block diagram of a computing device that may be utilized to implement one embodiment of the present invention.

### DESCRIPTION OF THE EMBODIMENTS

The following description is merely exemplary in nature and is not intended to limit the present disclosure, application or uses. It should be understood that throughout the drawings, corresponding reference numerals indicate like or corresponding parts and features.

Currently, customers use smart web-enabled devices (such smart phones or laptops) to communicate with social networking sites. There is, however, no linkage between such devices and a vehicle that allows for updates of vehicle-related information to social networking sites. Further, while driving, it may be illegal in some states for a driver to operate a web-enabled device to provide some of the updates of which he or she may be aware.

Embodiments of the present invention may allow users to more quickly and easily communicate with friends and family and to coordinate with their social networks, even when they are in their vehicles. Indeed, some of the above described shortcomings or problems may be overcome or lessened by one or more embodiments disclosed herein. In particular, an embodiment is directed to an infotainment system that automatically provides updates to a social networking site. For example, the embodiments disclosed herein may, automatically or based on a user response to a prompt, provide updates from the automobile to the social networking site associated with either the automobile or one or more of the users in the automobile. For example, based on information known by the infotainment system (or the automobile in general) the social networking site may receive information such as: navigation destination information (ex. estimated time of arrival at a destination or a point of interest), entertainment information (ex. current audio playing in the automobile), communication information (ex. who the driver or a passenger is speaking with on the telephone), or the user's carbon footprint at a particular time (e.g., “I'm running on Batteries”).

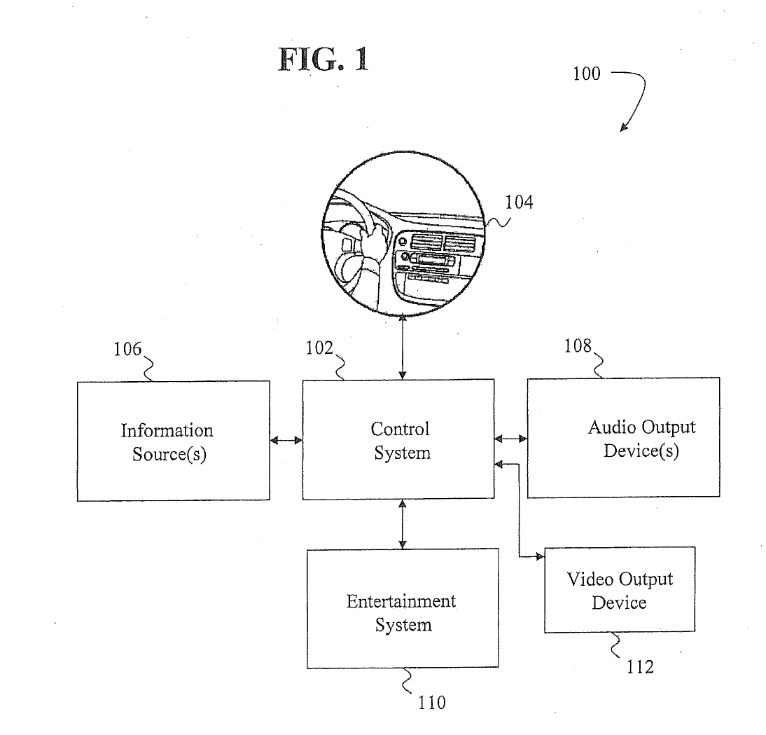

In accordance with an exemplary embodiment, FIG. 1 schematically illustrates an infotainment system 100 that may be utilized, for example, in an automobile (not shown). While the following discussion is based on implementation in an automobile, the teachings herein may be applied in other contexts. For example, the infotainment system 100 could be utilized on a motorcycle, all-terrain vehicle, or in a home entertainment system.

The infotainment system 100 (also referred to generally herein as “system”) may include an infotainment control system 102. The control system 102 receives inputs from various sources and may include portions that control various operations of the infotainment system 100. For example, and as discussed in greater detail below, the control system 102 may include a portion (sub-system) that controls access and updates to a user's social networking site. As used herein, the term “user” shall refer to any passenger in an automobile and includes the driver. In one embodiment, there may exist a “prime user” who is the usual or primary driver of the automobile.

The control system 102 may receive input signals from an information system 106. The information system 106 may include, but is not limited to, a navigation system, a personal digital assistant (PDA), a radio tuner, a cellular telephone, an Internet connection, a microphone, or any other device capable of providing information to the control system 102.

The control system 102 may also receive input signals from an entertainment system 110. The entertainment system 110 may include, but is not limited to, one or more of a compact disk (CD) player, a radio tuner, a digital video disk (DVD) player, a portable media player, or other now available or later created devices that provide entertainment.

In order for the information or entertainment provided by the information source 106 or entertainment system 110 to be experienced by a passenger, the control system 102 provides the information or entertainment to one or both of the audio output 108 or video output 112. The audio output 108 may be a system of one or more speakers and the video output 112 may be, for example, one or more display screens located at one or more locations in the automobile.

Typically, a user may control some or all of the infotainment system 100 through a user input device 104. Based on inputs received from the user input device 104, the control system 102 may determine the device that has access to one or both of the outputs 108 and 112. In addition, the user input device 104 may include buttons or other indicia (such a computer display screen) that allows a user to select one or more options while the automobile is operating.

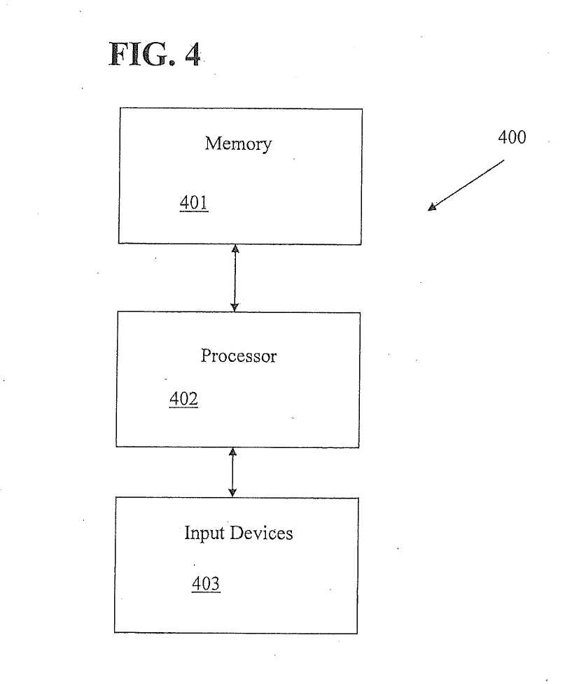

It shall be understood that the control system 102 may actually be implemented as a computing device. The control system 102, therefore, may be represented in detailed form as shown in FIG. 4, and described below.

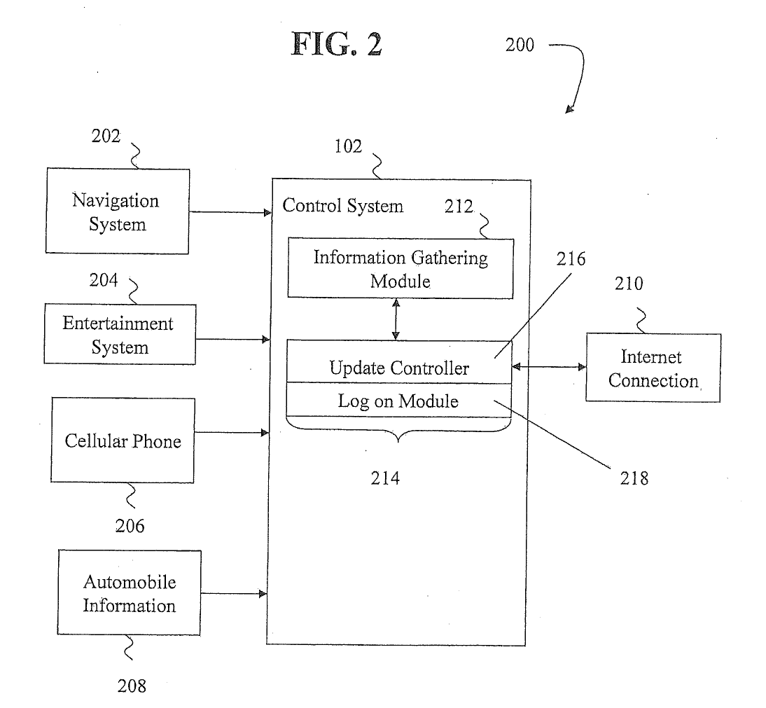

FIG. 2 shows a more detailed schematic of a portion of an infotainment system 200 according to an embodiment of the present invention. The portion shown may be referred to as a social networking hub.

The system 200 includes at least a portion of the control system 102. The control system 102 receives inputs from various sources and controls access to the infotainment output (typically speakers). In addition, the control system 102 may receive information from one or more sources and provide it to a user's social networking site(s). For example, the embodiments disclosed herein may, automatically or based on a user response to a prompt, provide updates from the automobile to a social networking site associated with either the automobile or one or more of the users in the automobile. Such updates may include navigation based information, or information about activities of one or more occupants of the automobile. Of course, the updates could be any type of information and the examples given herein are by way of example only.

The system 200 may include an entertainment system 204 coupled to the control system 102. The entertainment system 204 provides at least audio information to the control system 102. In some cases, the entertainment system 204 may also provide video information to the control system 102. The audio or video information may include metadata related to it. For example, the audio information may include the name of a particular song being played and the video information may include, for example, the name of a video or movie being played.

The system 200 may also include a navigation system 202 coupled to the control system 102. The navigation system 202 may include a global positioning system (GPS) navigation device to acquire position data to locate the automobile on a road in the unit's map database. Using the map database, the unit can give directions to other locations along roads also in its database. The directions may be given as a series of audio prompts (“prompts”). The control system 102 receives these prompts and, generally, provides them to the audio output 108, FIG. 1. The navigation system 202 may provide the control system 102 with navigation related information. For example, the navigation system 202 may provide the control system 102 with a desired destination or an estimated time of arrival. Of course, the navigation system 202 could provide additional information such as, for example, current location or possible route.

The system 200 may also include a cellular phone 206. The cellular phone 206 may provide information such as, for example, the person to whom the user is talking to, to the control system 102. The cellular phone 206 may be a portable handset or may be integrated into the infotainment system or otherwise integrated into the automobile.

The system 200 may also include a general automobile information module 208 coupled to the control system 102. The automobile information module 208 may gather information related to the operation of the automobile. For instance, the automobile information module 208 may gather the current gas mileage or operational mode (gas or electric) of an automobile and provide it to the control system 102.

The above system description is by way of example only. It will be understood that different input devices may be included and the inputs received from those devices may vary from those described above.

Regardless of the input sources, the control system 102 may include an information gathering module 212. The information gathering module 212 gathers information from one or more external sources. For example, the information gathering module 212 could gather the information described above from the navigation system 202, the entertainment system 204, the cellular phone 206 or the automobile information module 208. The information may be gathered on demand, whenever a source changes, periodically or some combination of these times.

The information gathering module 212 may be coupled to an update manager 214. Generally, the update manager 214 receives the information gathered by the information gathering module 212 and provides it to an internet connection 210. It shall be understood that the internet connection 210 may be created by the cellular phone 206 in some embodiments. It shall also be understood that the internet connection may provide information to the information gathering module 212 in some embodiments.

In one embodiment, the internet connection 210 provides a gateway to a user's social networking site(s). To that end, the update manager 214 may include an update controller 216. The update controller 216 may, based on user preferences that are previously recorded or configurable on-demand, determine when to update the user's social networking site and what information to provide to the site. It shall be understood that in some embodiments the social networking site may require that a user log on. To that end, the update manager 214 may include a log on manager 218 that provides passwords and the like to the site through the network connection 210. In some embodiments, the log on manager 218 may determine which social networking site to log on to based on the type of information received. For example, destination information may be provided to one site and gas mileage to another. Such preferences could be included in the update controller 216. In addition, different drivers, or different telephones, may cause the log on manager 218 to select different social networking sites to log on to depending, for example, on who the driver is. Such information may be acquired in many ways. For example, the number of the cellular phone 206 may indicate who is driving (or at least who's site should be updated).

In operation, the information gathering module 212 may receive a piece of information from any of the possible inputs. This information may be provided to the update manager 214 and, if the update controller 216 determines that the information should be uploaded to the user's social networking site, a connection is established and the information provided to the site through the internet connection 210.

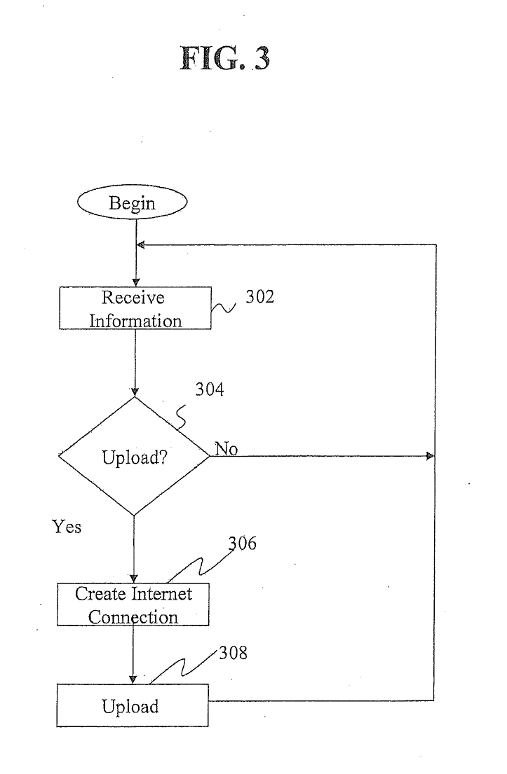

FIG. 3 shows a flow chart of a method according to one embodiment. At a block 302, one or more pieces of information are received by an information gathering module. The information may include, for example, navigation or infotainment related information.

At a block 304, an update controller may analyze the information to determine if it is to be uploaded. If so, at a block 306, a log on module creates a connection, though an internet connection, to a user's social networking site. It shall be understood that the connection may be established at any time and may be continually maintained in some embodiments.

At a block 308 the information is uploaded to the user's social networking site. After block 308, or in the event that at block 304 it was determined that the information was not to be uploaded, the process returns to block 302. Of course, the process may be ended by user intervention or when the automobile is turned off.

It is further noted that embodiments of the invention may be embodied in the form of computer-implemented processes and apparatuses for practicing those processes. Therefore, according to an exemplary embodiment, the methodologies described hereinbefore may be implemented by a computer system or apparatus. For example, FIG. 4 illustrates a computer system, according to an exemplary embodiment. Therefore, portions or the entirety of the methodologies described herein may be executed as instructions in a processor 402 of the computer system 400. The computer system 400 includes memory 401 for storage of instructions and information, and input device(s) 403 for computer communication. Thus, the present invention may be implemented, in software, for example, as any suitable computer program on a computer system somewhat similar to computer system 400. For example, a program in accordance with the present invention may be a computer program product causing a computer to execute the example methods described herein. In an embodiment, the computer system 400 may form some or all of the infotainment system described above. In an embodiment, the computer system 400 may form some of all of the control system 102 described above.

The computer program product may include a computer-readable medium having computer program logic or code portions embodied thereon for enabling a processor (e.g., 402) of a computer system (e.g., 400) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A social networking hub located in an automobile that provides updates to a social networking site, comprising:
an information gathering module that receives and stores information from one or more information sources; and
an update manager that receives information from the information gathering module and provides some or all of the information to the social networking site through an internet connection.

2. The social networking hub of claim 1, wherein the update manager comprises:
an update controller; and
a log-on module.

3. The social networking hub of claim 2, wherein the update controller determines which information received from the information gathering module is to be provided to the social networking site based on user preferences.

4. The social networking hub of claim 3, wherein the log-on module determines which of a plurality of social networking sites to access based on the information received from the information gathering module.

5. The social networking hub of claim 3, further comprising:
a navigation system coupled to the information gathering module that provides navigation information to the information gathering module.

6. The social networking hub of claim 5, wherein the navigation information includes as least one of: destination, current location and estimated time of arrival at destination.

7. The social networking hub of claim 3, further comprising:
an entertainment system coupled to the information gathering module that provides entertainment information to the information gathering module.

8. The social networking hub of claim 7, wherein the entertainment includes as least one of: a current song playing and a current movie playing.

9. The social networking hub of claim 3, further comprising:
a cellular telephone coupled to the information gathering module that provides an identification of at least one person currently on a telephone call with a passenger of the automobile to the information gathering module.

10. The social networking hub of claim 1, further comprising:
an internet connection device.

11. The social networking hub of claim 10, wherein the internet connection device is a cellular phone.

12. The social networking hub of claim 3, further comprising:
an vehicle information system coupled to the information gathering module that provides vehicle information to the information gathering module.

13. The social networking hub of claim 12, wherein the vehicle information includes at least one of: current operating mode and fuel economy.

14. A method of providing information related to a passenger of an automobile to the passenger's social networking site, the method comprising:
receiving the information at a social networking hub of an infotainment system of the automobile;
determining the information is to be uploaded to the social networking site;
creating a connection from the infotainment system to the social networking site over the Internet; and
uploading the information.

15. The method of claim 14, wherein the information is navigation information received from a navigation system.

16. The method of claim 15, wherein the navigation information includes at least one of: a current location, a destination and an estimated time of arrival at the destination.

17. The method of claim 14, wherein the information is entertainment information received from an entertainment system.

18. The method of claim 17, wherein the entertainment information is either an indication of a song being played or a movie being played.

19. The method of claim 14, wherein determining includes:
comparing the information to user defined preferences.

20. A computer program product including a computer readable medium with program segments for, when executed on a computer device, causing the computer device to implement a method for operating an infotainment system, the method comprising:
receiving the information at a social networking hub of an infotainment system of the automobile;
determining the information is to be uploaded to a social networking site;
creating a connection from the infotainment system to the social networking site over the Internet; and
uploading the information.
